(19) United States
(12) Patent Application Publication
(10) Pub. No.: US 2006/0105306 A1
(43) Pub. Date: May 18, 2006

(54) System and method for assessing psychological traits

(76) Inventors: Sherleen Sue Sisney, Prospect, KY (US); Kenneth John Linfield, Louisville, KY (US)

Correspondence Address: FROST BROWN TODD, LLC, 2200 PNC CENTER, 201 E. FIFTH STREET, CINCINNATI, OH, 45202, US

(21) Appl. No.: 10/993,573

(22) Filed: Nov. 18, 2004

(51) Int. Cl. G09B 19/00

(52) U.S. Cl. 434/236

(57) ABSTRACT

An operating style assessment reveals aspects of an individual's operating style. Operating style includes a plurality of dimensions, and each dimension has a plurality of categories corresponding to personality types. One dimension is thinking strategy. At least one of the categories is a drive. A scoring method includes comparing a difference between sums of numerical values representing answers to questions within a dimension to a threshold associated with the dimension to determine which category of the dimension an individual fits in. Other assessments include locus of control, interpersonal skills, and nonverbal skills. Assessments may be administered through the Internet, and results of assessments may be accessible by employers.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

The present invention relates in general to assessments of psychological traits of individuals. Everyone has psychological traits that influence one's mind or emotions and behavior. Moreover, everyone's psychological traits are unique. After all, it is one's unique traits that make each of us an individual. Many attempts have been made to assess a person's psychological traits, but no one prior to the inventors has created or used the invention described in the appended claims.

### BRIEF DESCRIPTION OF DRAWINGS

While the specification concludes with claims that particularly point out and distinctly claim the invention, it is believed the present invention will be better understood from the following description taken in conjunction with the accompanying drawings, in which like reference numerals identify the same elements. The drawing and detailed description which follow are intended to be merely illustrative and are not intended to limit the scope of the invention as set forth in the appended claims.

FIG. 1 depicts an exemplary system for assessing an individual's operating style.

FIG. 2 depicts a table showing an exemplary embodiment of the dimensions shown in FIG. 1.

FIG. 3 depicts the table of FIG. 2, with exemplary aspects designated within dimensions.

FIG. 4 depicts a block diagram showing an exemplary set of steps within an operating style assessment scoring algorithm.

FIG. 5 depicts a block diagram showing an exemplary set of steps for assessing an individual's operating style.

### DETAILED DESCRIPTION

The following description should not be used to limit the scope of the present invention. Other examples, features, aspects, embodiments, and advantages of the invention will become apparent to those skilled in the art from the following description, which includes by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

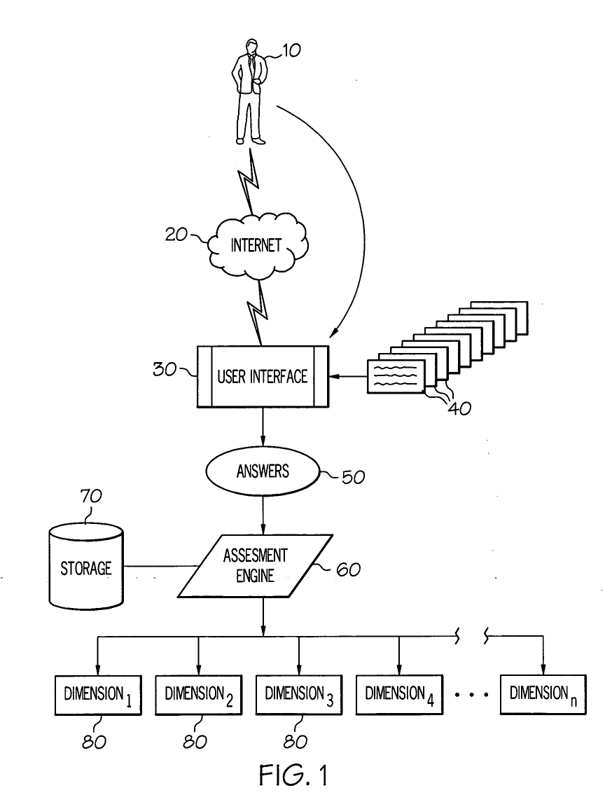

FIG. 1 depicts, in general terms, a computer-implemented embodiment of a system that may be used for assessing psychological traits of an individual (10). The system includes an assessment for determining aspects of the operating style of the individual (10). Operating style is an aspect of personality. It is enduring; it reveals different affects of behavior across many environments, as opposed to skill, knowledge or attitude. The operating style assessment will hereinafter be referred to as “the OSA.” As shown, the OSA is administered through a user interface (30). In the present example, the individual (10) accesses the user interface (30) via the internet (20). However, it will be appreciated that the individual (10) may access the user interface (30) on a closed network, on a computer without using a network, or by any other suitable means. Further, an intermediary, such as a nurse, clerk, assistant, HR manager, etc. may act as an intermediary and enter data through the user interface (30) about the individual (10).

The OSA comprises a plurality of questions (40). In the present example, the individual (10) is asked the questions (40) through the user interface (30). In response to the questions (40), the individual (10) provides answers (50) through the user interface (30). When answers (50) to all of the questions (40) have been received, the answers (50) are processed through an assessment engine (60), which scores the answers (50). Alternatively, the assessment engine (60) may process answers (50) as they are received, or at any suitable time or in any suitable manner. In one embodiment, the assessment engine (60) uses an OSA algorithm, which may be stored in a storage device (70). In addition, the storage device (70) may store at least a portion of the answers (50) or other data.

By processing the answers (50) through the assessment engine (60), the system may determine how the individual's (10) operating style fits within a predetermined set of dimensions (80). Aspects of the individual's (10) operating style will thereby be revealed.

It will be appreciated that any given individual's operating style may comprise several aspects. In the present example, each dimension (80) relates to a certain aspect of an individual's operating style. By way of example only, Dimension₁ (80) may relate to how the individual leads others or how the individual is most comfortable leading (“leadership”); Dimension₂ (80) may relate to the effects other people have on the individual or how the individual is most comfortable interacting with others (“effects of others”); Dimension₃ (80) may relate to the individual's most comfortable work pace (“work pace”); Dimension₄ (80) may relate to how the individual handles knowledge or the individual's most comfortable method of collecting and applying knowledge (“knowledge handling”); and Dimension₅ (80) may relate to the individual's primary thinking strategy (“thinking strategy”). Of course, dimensions (80) may relate to any other aspects of an individual's operating style. It will also be appreciated that a variety of differing numbers and considerations of dimensions (80) may be used.

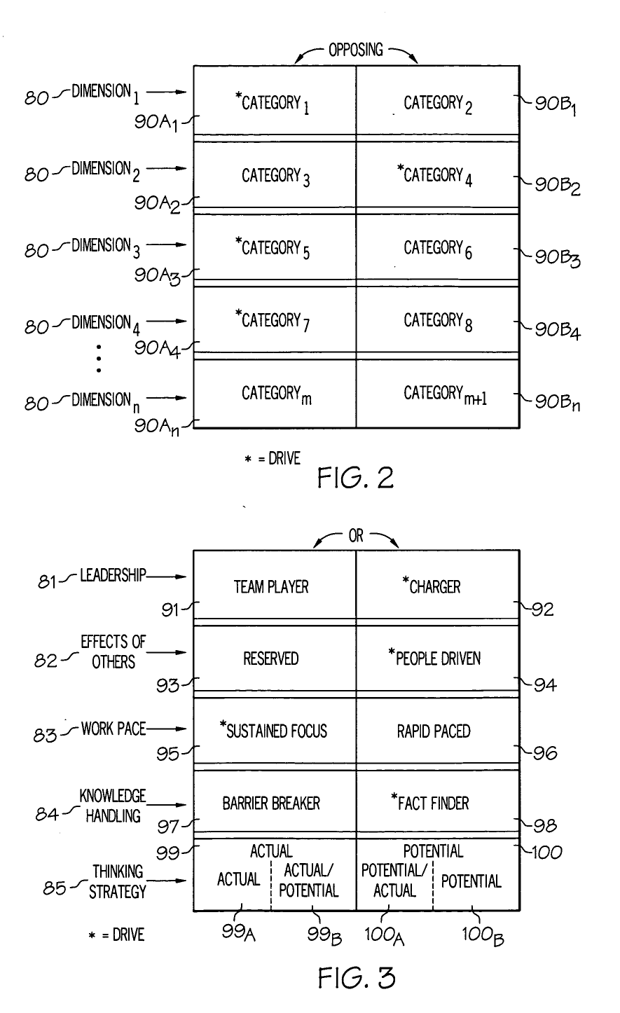

As shown in FIG. 2, each dimension (80) comprises a pair of categories (90A, 90B). Each category (90A, 90B) represents a personality type associated with the operating style aspect to which the corresponding dimension (80) relates. In the present example, each category (90A or 90B) within a given dimension (80) represents a personality type that is in conceptual opposition with the personality type represented by the other category (90B or 90A) within the same dimension (80). In other words, with respect to the operating style aspect corresponding to a given dimension (80), there exists a spectrum of personality types in which an individual may be categorized. This spectrum is represented by its extremes in the form of the designated categories (90A, 90B). Thus, one category (90A or 90B) will represent a personality type that falls on or defines a far end of the spectrum of personality types within the corresponding dimension (80); while the other category (90B or 90A) will represent the personality type that falls on or defines the other far end of the spectrum of personality types within the corresponding dimension (80).

In the embodiment shown in FIG. 2, Dimension, (80), which corresponds to a certain operating style aspect, comprises Category, (90A,) and Category₂ (90B₁). Within Dimension₁ (80), there exists a spectrum of personality types in which a given individual may be categorized with respect to the certain operating style aspect corresponding to Dimension₁ (80). Category₁ (90A₁) represents a personality type that falls on or defines one far end of this spectrum; while Category₂ (90B₁) falls on or defines the other far end of this spectrum. Category₁ (90A₁) thus represents a personality type that is in conceptual opposition with the personality type represented by Category₂ (90B₁).

The conceptual opposition of categories (90A, 90B) is illustrated in FIG. 3, which depicts a table with exemplary categories (90A, 90B) named within each dimension (80). In this example, the dimensions (80) comprise leadership (81), effects of others (82), work pace (83), knowledge handling (84), and thinking strategy (85). Of course, any other dimensions corresponding to aspects of an individual's operating style may be used. In addition, it will be appreciated that the categories discussed below are mere examples, and any other suitable categorizations may be made, even within the dimensions (80) of the present example.

As shown, the dimension of leadership (81) comprises the categories of team player (91) and charger (92). The category of team player (91) represents a personality type comprising any of the following characteristics: leads through encouragement; ensures that individuals' strengths are recognized and rewarded; is accommodating; gains strength and confidence through consultation with others; listens to and honors the ideas of others before asserting his or her own ideas; seeks harmony in a group. The category of charger (92) represents a personality type comprising any of the following characteristics: leads mostly by directing and delegating responsibilities; brings people together under his/her supervision; seeks to be in charge; quickly takes initiative; has self-sustaining confidence; is often competitive; shows strong leadership.

Accordingly, the personality type represented by team player (91) is in conceptual opposition with the personality type represented by charger (92) in terms of leadership (81) of the individual. Any given individual will thus be either more of a team player (91) or more of a charger (92) with respect to how the individual leads others or how the individual is most comfortable leading. In other words, an individual may be identified as being of the personality type of team player (91) or of charger (92) for the question “How do you lead?”

The dimension of effects of others (82) comprises the categories of reserved (93) and people driven (94). The category of reserved (93) represents a personality type comprising any of the following characteristics: likes spending time with people, but often needs time away to recharge; will often wait to fully formulate an opinion or idea until he or she has thought it through; is sometimes reluctant to engage in small talk and will wait until he or she can make a meaningful connection with someone. The category of people driven (94) represents a personality type comprising any of the following characteristics: is high energy and gains more energy by being around and interacting with other people; problem-solves aloud; is conscientious of others' perceptions; is adept and at ease in most social situations; is expressive and engaging; responds to the emotions of others.

Accordingly, the personality type represented by reserved (93) is in conceptual opposition with the personality type represented by people driven (94) in terms of the effects of others (82) on the individual. Any given individual will thus be either more reserved (93) or more people driven (94) with respect to the effects that other people have on the individual or how the individual is most comfortable interacting with others. In other words, an individual may be identified as being of the personality type of reserved (93) or of people driven (94) for the question “What effect do people have on you?”

The dimension of work pace (83) comprises the categories of sustained focus (95) and rapid paced (96). The category of sustained focus (95) represents a personality type comprising any of the following characteristics: is patient; is often described as laid-back or low-key; makes meaningful connections to people one on one; is steady and consistent; seeks security and stability. The category of rapid paced (96) represents a personality type comprising any of the following characteristics: moves quickly; is often impatient; enjoys lots of activities happening at once; seeks variety and change in routine; is often relieved to change tasks; can become bored easily.

Accordingly, the personality type represented by sustained focus (95) is in conceptual opposition with the personality type represented by rapid paced (96) in terms of the individual's work pace (83). Any given individual will thus either have more of a sustained focus (95) or be more rapid paced (96) with respect to the individual's most comfortable work pace (83). In other words, an individual may be identified as being of the personality type of sustained focus (95) or of rapid paced (96) for the question “What is your work pace?”

The dimension of knowledge handling (84) comprises the categories of barrier breaker (97) and fact finder (98). The category of barrier breaker (97) represents a personality type comprising any of the following characteristics: is unafraid of making a mistake; moves quickly with little information; is willing to take shortcuts to achieve an end; is not held back by rules or convention; does not like working with the details; is a risk taker. The category of fact finder (98) represents a personality type comprising any of the following characteristics: has a drive to gather information; has a need to work for something he or she believes in deeply; seeks to make sure everything is right; focuses on comprehending a situation.

Accordingly, the personality type represented by barrier breaker (97) is in conceptual opposition with the personality type represented by fact finder (98) in terms of the individual's knowledge handling (84). Any given individual will thus be either more of a barrier breaker (97), or more of a fact finder (98) with respect to how the individual handles knowledge or the individual's most comfortable method of collecting and applying knowledge. In other words, an individual may be identified as being of the personality type of barrier breaker (97) or of fact finder (98) for the question “How do you handle knowledge?”

The dimension of thinking strategy (85) comprises the categories of actual (99) and potential (100). The category of actual (99) represents a personality type comprising any of the following characteristics: is most comfortable with structure and order; likes to operate with a plan; thrives under deadlines; can articulate the steps needed to achieve the big picture; prefers to have decisions and plans made early and kept consistent; has clear and concise thinking; concentrates or focuses on existing details of a situation or idea. The category of potential (100) represents a personality type comprising any of the following characteristics: is uncomfortable with absolutes; likes to keep situations open for possibilities; can easily see the big picture, but often has trouble defining it; does not need or necessarily want a detailed plan; concentrates or focuses on the future possibilities of a situation or idea.

Accordingly, the personality type represented by actual (99) is in conceptual opposition with the personality type represented by potential (100) in terms of the individual's primary thinking strategy (85). Any given individual will thus have either more of an actual (99) thinking strategy (85), or more of a potential (100) thinking strategy (85). In other words, an individual may be identified as being of the personality type of actual (99) or of potential (100) for the question “What is your thinking strategy?”

It will be appreciated that a dimension (80) may comprise more than two categories (90A, 90B). Such additional categories may fall anywhere within the spectrum of personality types for the corresponding dimension (80). As used herein, the phrases “additional categories” and “sub-categories” shall be read interchangeably. In the present example, the dimension of thinking strategy (85) comprises four categories. As shown, the category of actual (99) comprises the sub-categories of actual (99A) and actual/potential (99B); while the category of potential (100) comprises the sub-categories of potential/actual (100A) and potential (100B). Actual/potential (99B) is positioned on the spectrum between actual (99A) and potential/actual (100A); while potential/actual (100A) is positioned on the spectrum between potential (100B) and actual/potential (99B). While the present example discusses the dimension (80) of thinking strategy (85) as comprising more than two categories (90A, 90B), it will be appreciated that any other dimension (80), if any at all, may comprise more than two categories (90A, 90B).

Each question (40) of the OSA corresponds to one of the categories (90A or 90B) of one of the dimensions (80). By “corresponding” to one of the categories (90A or 90B), each question (40) is devised to elicit an answer (50) that will be indicative of whether the individual (10) possesses or displays the personality type represented by the category (90A or 90B) to which the question (40) corresponds.

In the present example, the questions (40) of the OSA comprise at least one question (40) corresponding to each of the following: team player (91), charger (92), reserved (93), people driven (94), sustained focus (95), rapid paced (96), barrier breaker (97), fact finder (98), actual (99), and potential (100). In this example, the OSA does not include questions (40) corresponding directly to the sub-categories within the dimension of thinking strategy (85), but instead has questions corresponding directly to the categories therein of actual (99) and potential (100). Of course, where subcategories are used, one or more questions (40) of the OSA may correspond directly to one or more of the subcategories.

Thus, for a question (40) that corresponds to team player (91), the individual's (10) answer (50) to that question (40) will be indicative of whether the individual (10) is a team player (91). In other words, the answer (50) will be indicative of whether or not the individual (10) possesses or displays the personality type represented by the category of team player (91). In one embodiment, the answer (50) will indicate, at least in part, the extent to which the individual (10) possesses or displays the personality type represented by the category of team player (91).

Similarly, for a question (40) that corresponds to charger (92), the individual's (10) answer (50) to that question (40) will be indicative of whether or not the individual (10) possesses or displays the personality type represented by the category of charger (92). Such correspondence will exist as to all of the other categories (93, 94, 95, 96, 97, 98, 99, and 100), as well, for each category will have at least one corresponding question (40).

To be indicative of whether the individual (10) possesses or displays a particular personality type, the answers (50) may be provided in any suitable form. By being indicative of whether the individual (10) possesses or displays a particular personality type, such answers (50) will hereinafter be referred to as “binary answers.” By way of example only, such binary answers (50) may be provided in the form of a “yes” or a “no” indicator; or in the form of a “true” or “false” indicator. Such binary answers (50) may be represented by a numerical value. By way of example only, a “1” may represent a “yes” or “true” answer (50), while a “0” may represent a “no” or “false” answer (50). Binary answers may also be considered “forced choice” answers.

Similarly, to be indicative of the extent to which the individual (10) possesses or displays a particular personality type, the answers (50) may be provided in a non-binary form. By being indicative of the extent to which the individual (10) possesses or displays a particular personality type, such answers (50) will hereinafter be referred to as “scale answers.” By way of example only, scale answers (50) may be based on a Likert scale system. In one embodiment, scale answers (50) are provided in the form of an indicator representing one of the following: “never,” “seldom,” “neutral,” “often,” or “always.” Of course, these examples are merely illustrative, and scale answers (50) may be provided in the form of an indicator representing any other degree. Such alternatives may include any suitable number or types of degrees.

As with binary answers (50), scale answers (50) may be represented by numerical values. By way of example only, each scale answer (50) may be represented by any value from 1 to 5—with “1” representing “never,” “2” representing “seldom,” “3” representing “neutral,” “4” representing “often,” and “5” representing “always.” Of course, these numerical values are merely illustrative, as are the degrees that they represent. It will be appreciated that any suitable alternative number of degrees, types of degrees, and/or numerical values may be used. The numerical values need not be whole numbers, and may include fractions or decimals.

In one embodiment, the OSA questions (40) come in the form of statements. Each of the statements sets forth a personality trait with which the individual (10) may or may not personally identify with. Each of these personality traits will be consistent with or representative of the personality type represented by the category (90A or 90B) corresponding to the respective question (40). In this embodiment, the answers (50) indicate whether or the extent to which the individual (10) feels that the statements apply to the individual (10). The answers (50) will thereby indicate whether or the extent to which the individual (10) possesses or displays the personality type represented by the category (90A or 90B) corresponding to the respective question (40). To illustrate such use of statements as questions (40), any of the following merely exemplary OSA questions (40) may be used:
1. I like to complete one task before starting a new one.
2. I lead as an individual.
3. I like to be in the middle of things with lots of people.
4. When working on a project, I handle the details myself.
5. I like frequent change.
6. Once one of my visions becomes a reality, I create a new vision.
7. I am likely to listen to others' ideas before contributing my own.
8. I let others take care of details.
9. I like structure and organization.
10. Working alone does not bother me.
11. I would rather not draw attention to myself.
12. I like to move around rather than stay in one place.
13. I require an orderly environment for work.
14. I prefer to work with others than to direct others.
15. I worry about making mistakes.
16. I am comfortable meeting and approaching new people.
17. I prefer to work at a steady, constant pace.
18. I am assertive and in control most of the time.
19. I often surprise people with my opinions.
20. I tend to organize thinks in my mind, rather than in a detailed written plan.
21. I consider myself to be friendly and outgoing.
22. Frequently having to talk and be around people drains my energy level.
23. I am intense.
24. I am quick to assert my own ideas.
25. I readily express unusual or different opinions.
26. I work best in an orderly environment.
27. I do not require order to get things finished.
28. I avoid conflict.
29. It bothers me when I have to break the rules.
30. I am patient.
31. I am comfortable talking and thinking at the same time.
32. I am frank and direct.
33. I like to think about things before I do them.
34. I am often uncomfortable in a room full of strangers.
35. I work best when I feel calm and comfortable.
36. I often do things based on instinct and do not need to follow a plan.
37. I feel like things do not happen fast enough.
38. I need little information to be convinced of the value of an idea.
39. It bothers me when things are not settled and decided.
40. I fear being wrong.
41. When working on a project, I prefer input and guidance from others.
42. I am usually peppy and excited.
43. It is important for me to be in control.
44. I put more value on the definite than the open-ended.
45. I rarely sit still.
46. I put more value on the open-ended than the definite.
47. I feel at home in a relaxed setting.
48. I gather a lot of information before making decisions.
49. In order to make small talk, I need to find a connection with the person.
50. I frequently act on new ideas without having done any research.

The foregoing questions are subject to copyrights of Assessment Properties, LLC, 2004, all rights reserved.

Of course, the foregoing exemplary questions (40) are not intended to be limiting in any way, and any other suitable OSA questions (40) may be used. It will also be appreciated that the foregoing exemplary questions (40) could be answered by binary answers (50), scale answers (50), or combinations thereof. In other words, the individual (10) may respond to the foregoing questions (40) by indicating whether the statements forming the questions (40) apply to the individual (10) (i.e., whether the individual (10) personally identifies with the personality trait set forth in the statement), and/or the extent to which the statements apply to the individual (10).

In the present example, each of the foregoing exemplary OSA questions (40) corresponds to one of the exemplary categories (91, 92, 93, 94, 95, 96, 97, 98, 99, and 100). The following listing, which is not intended to be limiting in any way, illustrates how the foregoing set of exemplary questions (40) correspond to the exemplary categories (91, 92, 93, 94, 95, 96, 97, 98, 99, and 100):
Question #1 corresponds to sustained focus (95).
Question #2 corresponds to charger (92).
Question #3 corresponds to people driven (94).
Question #4 corresponds to fact finder (98).
Question #5 corresponds to rapid paced (96).
Question #6 corresponds to potential (100).
Question #7 corresponds to team player (91).
Question #8 corresponds to barrier breaker (97).
Question #9 corresponds to actual (99).
Question #10 corresponds to reserved (93).
Question #11 corresponds to reserved (93).
Question #12 corresponds to rapid paced (96).
Question #13 corresponds to actual (99).
Question #14 corresponds to team player (91).
Question #15 corresponds to fact finder (98).
Question #16 corresponds to people driven (94).
Question #17 corresponds to sustained focus (95).
Question #18 corresponds to charger (92).
Question #19 corresponds to barrier breaker (97).
Question #20 corresponds to potential (100).
Question #21 corresponds to people driven (94).
Question #22 corresponds to reserved (93).
Question #23 corresponds to rapid paced (96).
Question #24 corresponds to charger (92).
Question #25 corresponds to barrier breaker (97).
Question #26 corresponds to actual (99).
Question #27 corresponds to potential (100).
Question #28 corresponds to team player (91).
Question #29 corresponds to fact finder (98).
Question #30 corresponds to sustained focus (95).
Question #31 corresponds to people driven (94).
Question #32 corresponds to charger (92).
Question #33 corresponds to sustained focus (95).
Question #34 corresponds to reserved (93).
Question #35 corresponds to team player (91).
Question #36 corresponds to potential (100).
Question #37 corresponds to rapid paced (96).
Question #38 corresponds to barrier breaker (97).
Question #39 corresponds to actual (99).
Question #40 corresponds to fact finder (98).
Question #41 corresponds to team player (91).
Question #42 corresponds to people driven (94).
Question #43 corresponds to charger (92).
Question #44 corresponds to actual (99).
Question #45 corresponds to rapid paced (96).
Question #46 corresponds to potential.
Question #47 corresponds to sustained focus (95).
Question #48 corresponds to fact finder (98).
Question #49 corresponds to reserved (93).
Question #50 corresponds to barrier breaker (97).

Thus, for instance, where an individual (10) provides an answer of “5” to represent “always” in response to question #1, such an answer would tend to indicate that the individual (10) possesses or displays a personality type that is consistent with the personality type represented by the category of sustained focus (95).

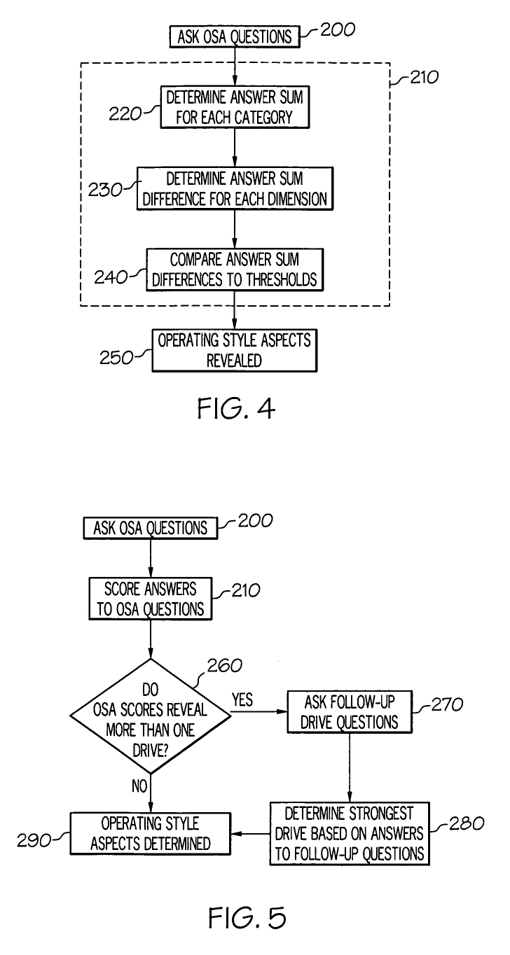

The OSA may be scored using numerical values representing the answers (50) to the questions (40). An embodiment of such scoring is shown in phantom block (210) of FIG. 4. The scoring (210) includes first determining an answer sum for each category (220). This may be accomplished by adding all of the numerical values representing answers (50) to the questions (40) corresponding to a given category (90A or 90B). When this is complete, each category (90A or 90B) will thus have an answer sum associated with the category (90A or 90B). While the present example will be discussed in the context of scale answers (50), it will be appreciated that answer sums may also be obtained in the context of binary answers (50), as either type of answer (50) is capable of numerical representation.

In the present example, the numerical values representing the answers (50) to the questions (40) corresponding to team player (91) are added to determine an answer sum for team player (91). Similarly, the numerical values representing the answers (50) to the questions (40) corresponding to charger (92) are added to determine an answer sum for charger (92). Answer sums are determined for each of the remaining categories (93, 94, 95, 96, 97, 98, 99, and 100) in a like manner.

The answer sums are then grouped by the dimensions (80) corresponding to the respective categories (90A or 90B) to determine answer sum differences (230) for each dimension (80). In the present example, an answer sum difference for leadership (81) is determined by subtracting the answer sum for team player (91) from the answer sum for charger (92). An answer sum difference for effects of others (82) is determined by subtracting the answer sum for reserved (93) from the answer sum for people driven (94). An answer sum difference for work pace (83) is determined by subtracting the answer sum for rapid paced (96) from sustained focus (95). An answer sum difference for knowledge handling (84) is determined by subtracting the answer sum for barrier breaker (97) from the answer sum for fact finder (98). An answer sum difference for thinking strategy (85) is determined by subtracting the answer sum for potential (100) from the answer sum for actual (99).

For example, in one embodiment, for determining the answer sum differences (230) for scoring (210), the minuends are the answer sums for charger (92), people driven (94), sustained focus (95), fact finder (98), and actual (99); while the subtrahends are the answer sums for team player (91), reserved (93), rapid paced (96), barrier breaker (97), and potential (100), respectively. Of course, any other suitable minuend-subtrahend relationship(s) may be used to determine answer sum differences (230). By way of example only, the minuend-subtrahend status may be reversed as to the categories (90A and 90B) comprising any dimension (80). It will also be appreciated that, while the present example discusses answer sum differences where numerical values represent scale answers (50), answer sum differences may also be obtained in where numerical values represent binary answers (50).

In the present example, a numerical threshold is associated with each dimension (80). When the answer sum differences have been determined (230) for each dimension (80), each answer sum difference may be compared to the threshold (240) associated with the corresponding dimension (80). Where the answer sum difference exceeds the respective threshold, the individual (10) is deemed to possess or display a personality type represented by one of the categories (90A or 90B) comprising the corresponding dimension (80). Where the answer sum difference meets or falls below the respective threshold, the individual (10) is deemed to possess or display the personality type represented by the other category (90B or 90A) comprising the corresponding dimension (80). Where subcategories are used, the answer sum difference corresponding to the dimension (80) that comprises the subcategories may be compared to numerical ranges to determine the subcategory that represents the personality type possessed or displayed by the individual (10). Thus, a threshold may comprise numerical ranges rather than a single number. Any other suitable relationships between answer sum differences and thresholds, including numerical ranges, may be utilized to determine a personality type possessed or displayed by an individual (10).

In the present example, where each answer (50) is represented by a number between 1 and 5, the dimension of leadership (81) is associated with a threshold of 0. If the answer sum difference for leadership (81) (i.e. the answer sum for charger (92) minus the answer sum for team player (91)) is greater than zero, the individual (10) is deemed to possess or display the personality type represented by charger (92); whereas if the answer sum difference for leadership (81) is less than or equal to zero, the individual (10) is deemed to possess or display the personality type represented by team player (91). Comparison of the answer sum difference for leadership (81) to the threshold associated with leadership (81) thus reveals the aspect of the individual's (10) operating style relating to how the individual (10) leads others.

In the present example, the dimension of effects of others (82) is associated with a threshold of 6. If the answer sum difference for effects of others (82) (i.e. the answer sum for people driven (94) minus the answer sum for reserved (93)) is greater than 6, the individual (10) is deemed to possess or, display the personality type represented by people driven (94); whereas if the answer sum difference for effects of others (82) is less than or equal to 6, the individual (10) is deemed to possess or display the personality type represented by reserved (93). Comparison of the answer sum difference for effects of others (82) to the threshold associated with effects of others (82) thus reveals the aspect of the individual's (10) operating style relating to the effects other people have on the individual (10).

In the present example, the dimension of work pace (83) is associated with a threshold of 3. If the answer sum difference for work pace (83) (i.e. the answer sum for sustained focus (95) minus the answer sum for rapid paced (96)) is greater than 3, the individual (10) is deemed to possess or display the personality type represented by sustained focus (95); whereas if the answer sum difference for work pace (83) is less than or equal to 3, the individual (10) is deemed to possess or display the personality type represented by reserved (93). Comparison of the answer sum difference for work pace (83) to the threshold associated with work pace (83) thus reveals the aspect of the individual's (10) operating style relating to the individual's (10) work pace.

In the present example, the dimension of knowledge handling (84) is associated with a threshold of −2. If the answer sum difference for knowledge handling (84) (i.e. the answer sum for fact finder (98) minus the answer sum for barrier breaker (97)) is greater than −2, the individual (10) is deemed to possess or display the personality type represented by fact finder (98); whereas if the answer sum difference for knowledge handling (84) is less than or equal to −2, the individual (10) is deemed to possess or display the personality type represented by barrier breaker (97). Comparison of the answer sum difference for knowledge handling (84) to the threshold associated with knowledge handling (84) thus reveals the aspect of the individual's (10) operating style relating to how the individual (10) handles knowledge.

In the present example, the dimension of thinking strategy (85) is associated with numerical ranges, rather than a single threshold number. Such ranges may facilitate the classification of the individual (10) into one of the sub-categories (99A, 99B, 100A, or 100B). If the answer sum difference for thinking strategy (85) (i.e. the answer sum for actual (99) minus the answer sum for potential (100)) is greater than 4, the individual (10) is deemed to possess or display the personality type represented by actual (99A). If the answer sum difference for thinking strategy (85) is between 0 and 4, inclusive of both, the individual (10) is deemed to possess or display the personality type represented by actual/potential (99B). If the answer sum difference for thinking strategy (85) is between −4 and −1, inclusive of both, the individual (10) is deemed to possess or display the personality type represented by potential/actual (100A). If the answer sum difference for thinking strategy (85) is less than −4, the individual (10) is deemed to possess or display the personality type represented by potential (100B). Comparison of the answer sum difference for thinking strategy (85) to the threshold associated with thinking strategy (85) thus reveals the aspect of the individual's (10) operating style relating to the individual's (10) thinking strategy.

Accordingly, after the answer sum differences have been compared to the respective thresholds or numerical ranges comprising thresholds, aspects of the individual's (10) operating style are revealed (250). While the present example has been discussed in the context of scale answers (50), it will be appreciated that answer sum differences for binary answers (50) may also be compared to thresholds and/or numerical ranges comprising thresholds.

Those of ordinary skill in the art will also appreciate that the thresholds and/or numerical ranges comprising a threshold may be dependent upon which category (90A or 90B) in a given dimension (80) is treated as the minuend and which category (90B or 90A) is treated as the subtrahend during the steps of determining answer sum differences (230). Thus, if the minuend-subtrahend status is reversed among categories (90A and 90B) comprising a certain dimension (80), the threshold or numerical range associated with that dimension (80) may need to change.

Any or all of the steps of scoring the OSA (210) may be performed on a computer system. Thus, the scoring rules and/or algorithm(s) may be stored in a computer readable medium that is in communication with a processor operable to perform the scoring. Accordingly, where the OSA is administered via the internet (20), the OSA may be scored remotely from the individual (10), who can receive the results shortly after submitting his or her final answer (50). In one embodiment, the storage device (70) comprises a computer readable medium in which the scoring rules and/or algorithm(s) are stored, while the assessment engine (60) includes a processor comprising instructions to perform the scoring.

It may be useful or otherwise desirable to designate one of the categories (90A or 90B) within at least one dimension (80) as a “drive.” As used herein, the term “drive” shall be read to include the specific element of style that is the primary motivation for an individual's learning and decision-making. Those of ordinary skill in the art will appreciate that a drive may be an intrinsic motivator or an extrinsic motivator. It will also be appreciated that the designation of one or more categories (90A or 90B) within a given dimension (80) as a drive is purely optional, and that not all dimensions (80) need to have a drive designated therein. In the present embodiment, charger (92), people driven (94), sustained focus (95), and fact finder (98) are each designated as drives. However, neither actual (99) nor potential (100) is designated as a drive, and therefore the dimension of thinking strategy (85) lacks a designated drive. Other suitable drive designations will be apparent to those of ordinary skill in the art, including but not limited to the designation of categories (90A or 90B) not expressly disclosed herein as drives.

FIG. 5 illustrates a process that may be performed when the OSA scoring (210) reveals that the individual (10) has more than one drive (260). In this situation, it may be desirable to determine which of the drives possessed or displayed by the individual (10) is the strongest or primary drive (e.g., what is the individual's foremost motivation). Upon a determination that the individual (10) has more than one drive (260), the individual (10) may be asked one or more follow-up questions (270). The strongest drive possessed or displayed by the individual (10) may be determined based on the answers to these follow-up questions (280).

The drive follow-up questions may be provided in any suitable form. In one embodiment, the drive follow-up questions are provided in multiple choice form. By way of example only, the following questions may be used as drive follow-up questions:
1. As a member of a group responsible for completing a project, I am best suited to:
   a. take charge and direct others
   b. create the most effective marketing technique/sales pitch
   c. help the group get along with each other
   d. take the lead, if others don't, to perfect the project
2. In a political campaign, I would be more likely to focus on:
a. making sure the platform is right
   b. listening to the concerns of campaign workers
   c. creating the network that gets others involved
   d. running the campaign
3. In a disagreement, I am more likely to:
   a. patiently listen to the opposing views
   b. confront
   c. use facts to present my side
   d. persuade others and win them over
4. In a work situation, the position for which I am best suited is:
   a. director of public relations/marketing
   b. director of project development
   c. chief executive officer
   d. director of customer service
5. The phrase that best describes my working style is:
   a. patient and focused
   b. calm and steady
   c. focused on “getting it right”
   d. directed toward problem-solving
6. When working to complete a task, I am most effective if:
   a. I concentrate on avoiding mistakes
   b. I am not hurried
   c. I have lots of information
   d. I am not interrupted
7. When entering a room full of strangers, I am most likely to:
   a. look for a group that is like me and approach them
   b. eagerly approach the opportunity to network with lots of people
   c. find one or two people and talk to them
   d. work to meet and know as many people as possible

The foregoing questions are subject to copyrights of Assessment Properties, LLC, 2004, all rights reserved.

Of course, the foregoing questions are not intended to be limiting in any way, and any suitable alternatives my be used. In the present example, the individual (10) is asked to select the answer from the multiple choices that best describes how the individual (10) would react in the given scenario. The answers will indicate which drive is the strongest in the individual (10).

To illustrate, consider an example where the answers (50) to the OSA questions (40) indicate that the individual (10) possesses or displays the drives of charger (92) and fact finder (98). The individual's answers to the follow-up questions indicate that the individual's strongest drive is charger (92). Thus, the individual (10) is primarily motivated by leadership. However, where the individual's answers to the follow-up questions indicate that the individual's strongest drive is fact finder (98), the individual (10) is primarily motivated by comprehending the situation.

Suitable techniques for scoring or analyzing answers to drive follow-up questions to determine which drive is strongest will be apparent to those of ordinary skill in the art. In the present example, the drive follow-up questions relate to four drives—charger (92), people driven (94), sustained focus (95), and fact finder (98). In this example, the individual's responses to the drive follow-up questions will indicate one of these four as being the strongest drive. In other words, each answer will correspond to a certain drive. The strongest drive is determined by tallying the number of answers corresponding to a given drive. Whichever drive has the highest correspondence with the answers to the drive follow-up questions will be deemed the strongest.

In one embodiment, where an answer to a drive follow-up question corresponds to a drive that was not revealed by the scoring (210) of the first portion of the OSA as being possessed or displayed by the individual (10), that answer is not considered during the scoring or analysis of the drive follow-up questions (280). For instance, if the first portion of the OSA reveals that an individual (10) possesses or displays the drives of only people driven (94) and sustained focus (95), and an answer to a drive follow-up question corresponds to the drive of fact finder (98), that answer corresponding to fact finder (98) will not be considered during the scoring or analysis of the drive follow-up questions (280). Thus, in this embodiment, the individual's strongest drive must be selected from the drives that were revealed or identified in the scoring (210) of the first portion of the OSA.

In the present example, where the scoring or analysis of the drive follow-up questions (280) results in a “tie” between two or more drives, or the results of the drive follow-up questions are otherwise inconclusive, the strongest drive may be determined by assessing the extent to which the answer sum differences that revealed the drives exceed their respective thresholds. For instance, if the first portion of the OSA reveals that an individual (10) possesses or displays the drives of people driven (94) and sustained focus (95), and the drive follow-up questions are inconclusive on the issue of which of these drives is the strongest, the strongest drive may be determined by comparing the extent to which the answer sum difference for effects of others (82) exceeds 6 (the threshold associated with effects of others (82)), versus the extent to which the answer sum difference for work pace (83) exceeds 3 (the threshold associated with work pace (83)). If the answer sum difference for effects of others (82) exceeds 6 to a greater extent than the extent to which the answer sum difference for work pace (83) exceeds 3, then the drive of people driven (94) will be deemed the strongest.

In one embodiment, a given answer to a drive follow-up question provisionally corresponds with more than one drive, such that the particular drive with which the answer ultimately corresponds is contingent upon which drives are revealed in the scoring (210) of the first portion of the OSA. In one embodiment, a plurality of answers to the drive follow-up questions each provisionally correspond with both sustained focus (95) and people driven (94). In this embodiment, where the scoring (210) of the first portion of the OSA reveals the drives of people driven (94) and rapid paced (96), those aforementioned answers will ultimately correspond with people driven (94). However, if the particular combination of people driven (94) and rapid paced (96) is not revealed by the scoring (210) of the first portion of the OSA, then the aforementioned answers will ultimately correspond with sustained focus (95).

In another embodiment, a plurality of answers to the drive follow-up questions each provisionally correspond with both people driven (94) and sustained focus (95). In this embodiment, where the scoring (210) of the first portion of the OSA reveals the drives of sustained focus (95) and reserved (93), those aforementioned answers will ultimately correspond with sustained focus (95). However, if the particular combination of sustained focus (95) and reserved (93) is not revealed by the scoring (210) of the first portion of the OSA, then the aforementioned answers will ultimately correspond with people driven (94).

Other suitable designations and/or combinations for provisional correspondence and/or ultimate correspondence between answers to drive follow-up questions and drives will be apparent to those of ordinary skill in the art. In addition, other suitable contingencies which lead to an ultimate correspondence will be apparent to those of ordinary skill in the art.

If the scoring of the first portion of the OSA reveals that the individual (10) has no drives, the drive follow-up questions need not be administered. In addition, if the scoring of the first portion of the OSA reveals that the individual (10) has no drives, then the individual (10) and/or the individual's answers (50) may be “flagged.” In this embodiment, such “flagging” may trigger closer inspection and analysis of at least a portion of the individual's answers (50) to the first portion of the OSA. The general approach to this may be to find “critical items” in the first portion of the OSA. For example, typically the critical items would be those that correlate most strongly with the initial criterion of styles determined by interviews.

Similarly, if the scoring of the first portion of the OSA reveals that the individual (10) has all of the drives (e.g., all four of the drives), the individual (10) and/or the individual's answers (50) may be “flagged.”

Suitable alternative techniques for scoring and/or analyzing an individual's responses/answers to drive follow-up questions will be apparent to those of ordinary skill in the art.

Ultimately, as shown in FIG. 5, regardless of the number of drives possessed or displayed by the individual (10), the aspects of the individual's (10) operating style may be determined (290) through administration of the OSA.

Another embodiment of the invention comprises a locus of control assessment. One embodiment of the locus of control assessment measures how much internality or feeling of control an individual possesses. Those of ordinary skill in the art will appreciate that increased internality may be linked to excelled performance in school and/or work, as compared to decreased internality (e.g., externality). Individuals designated as “internal” tend to have a sense of personal responsibility for decisions and actions. By contrast, individuals designated as “external” tend to feel a certain lack of control over what happens to them. External individuals tend to see the world as one that is more controlled by luck or other powerful people than by themselves. External individuals may make excuses or blame circumstances on others for the individual's behavior or work. Determining whether an individual is internal or external may be desirable at least in part because, as will be appreciated by those of ordinary skill in the art, internality may be increased by helping an external individual to set and achieve goals that the individual thought was unattainable. The degree of internality or externality has the potential to affect the interpretation and application of the OSA. Specifically, internality and externality may impact the description of an individual's operating style.

The questions for the locus of control assessment may be provided in any suitable form. In one embodiment, the locus of control answers are provided in “True or False” form. By way of example only, the following questions may be used for a locus of control assessment:
1. I can influence others' ideas.
2. Luck or chance has a lot to do with what happens in my life.
3. I often feel like I don't have any influence over others.
4. Even when I plan I am still unprepared.
5. Bad things happen because of poor choices I've made.
6. My accomplishments are recognized less often than other people's accomplishments.
7. I am blamed more often than other people for things that have gone wrong.
8. My abilities, more than chance, will get me ahead.
9. Often, there is no action I can take to change the future.
10. Taking advantage of opportunities affects my life more than chance.
11. I don't have much authority or power.
12. The system determines what happens to me.
13. I have many choices and opportunities in life.
14. I will move ahead in life because of the skills I have developed.
15. Fate has allowed powerful people to get where they are.
16. I am in control of my life.
17. Bad things happen no matter what choices are made.
18. I have control over my professional relationships.
19. I rely a lot on luck.
20. If someone is mad at me, it's usually for a good reason.
21. I am usually prepared for the future.
22. People listen to me.
23. Problems will usually go away if I don't mess with them.
24. If I work hard enough, I can get ahead.
25. I believe superstitions affect my life.
26. Evaluations of my work are usually accurate.
27. I have lots of inner strength.
28. There are some skills I will never be good at, no matter how much a practice.
29. It doesn't matter whether or not I work hard; things still turn out the same.
30. I have a voice in what happens to me.
31. People give me the respect I deserve.
32. My job performance doesn't affect whether or not I receive promotions.
33. I can help to shape the environment I work and live in.
34. I don't have many choices or opportunities in life.

The foregoing questions are subject to copyrights of Assessment Properties, LLC, 2004, all rights reserved.

Of course, the foregoing questions are not intended to be limiting in any way, and any suitable alternatives my be used. In the present example, the individual (10) is asked to select from “True” or “False” to indicate whether the individual (10) feels that each statement applies to them. The answers to these questions will ultimately indicate whether the individual (10) has an internal or external locus of control. While the present example uses binary answers, it will be appreciated that locus of control may be determined with the use of scale answers. Various suitable scoring techniques will be apparent to those of ordinary skill in the art.

Another embodiment of the invention comprises an interpersonal skills assessment. One embodiment of the interpersonal skills assessment measures the degree of hostility or friendliness an individual uses to interact with others. The results of this assessment may not indicate that an individual behaves the same way all of the time. The results may act as a warning signal of how the individual may react to others under stress or in unfavorable circumstances. Knowledge of an individual's interpersonal skills may be relevant to the preservation of a desirable work, classroom, or other environment. It may also be relevant to the preservation of relationships and/or opportunities. The degree of hostility or friendliness has the potential to affect the interpretation and application of the OSA. Specifically, hostility and friendliness may impact the description of an individual's operating style.

The questions for the interpersonal skills assessment may be provided in any suitable form. By way of example only, the following questions may be used for an interpersonal skills assessment:
1. How often are you bubbly?
2. How often are you spiteful?
3. How often are you heartless?
4. How often are you gentle?
5. How often are you kindhearted?
6. How often are you withdrawn?
7. How often are you soothing?
8. How often are you pleasant?
9. How often are you cooperative?
10. How often are you reassuring?
11. How often are you kind?
12. How often are you supportive?
13. How often are you unfeeling?
14. How often are you arrogant?
15. How often are you affectionate?

The foregoing questions are subject to copyrights of Assessment Properties, LLC, 2004, all rights reserved.

Of course, the foregoing questions are not intended to be limiting in any way, and any suitable alternatives my be used. In the present example, the individual (10) is asked to select from whole numbers ranging from 1 to 8 to indicate how often the statement describes the individual (10), with “1” representing “never” and “8” representing “always.” The answers to these questions will be indicative of the individual's interpersonal skills. While the present example uses scale answers, it will be appreciated that interpersonal skills may be determined with the use of binary answers. Various suitable scoring techniques will be apparent to those of ordinary skill in the art.

Another embodiment of the invention comprises a nonverbal language assessment. In one embodiment, the nonverbal language assessment is a component of the interpersonal skills assessment. In another embodiment, the nonverbal language assessment is a separate assessment. The nonverbal language assessment measures an individual's awareness and accurate interpretation of nonverbal language conveyed through facial and vocal expressions, postures, gestures, proximity, and the like. Those of ordinary skill in the art will appreciate that an individual's ability to communicate nonverbally effectively (e.g., to send and receive nonverbal messages accurately) may be a crucial skill for success in school, the workplace, and/or elsewhere.

Any of the aforementioned assessments may be administered in combination (e.g., as a package) or in isolation. It will be appreciated that, where more than one assessment is administered, the assessments may be administered in any suitable order. In addition, any other assessment(s) may be added to the assessment package. Those of ordinary skill in the art will also appreciate that any assessment may comprise audio and/or one or more images, such as photos and the like.

The results of the assessment(s) may be understood by those who lack formal training in psychology. In other words, by being in easily comprehensible terms, the results may leave less to inference than conventional assessments. Those of ordinary skill in the art will immediately recognize that results of any of the assessment(s) may be useful in an employment, education, or other setting. In other words, by having a holistic view of an individual's (10) operating style, locus of control, interpersonal skills, and/or nonverbal skills, an employer may make better judgments as to the optimum work environment for the individual (10), thereby leading to better informed employment decisions. It will be appreciated that the assessments described herein may give specific direction and provide a vocabulary for easily comprehensible management information. Results of assessments may also provide guidance to employers or educators on optimum training or education conditions for an individual (10). Thus, assessment results may facilitate the development of the individual (10) in an employment, education, or other setting. In addition, knowledge and understanding of an individual's operating style, such as through aspects revealed by the OSA, may decrease employee turnover and increase profits through increased employee retention.

In one embodiment, a user profile is kept for an individual (10). This user profile includes information associated with the individual (10). Such information may include answers (50) provided by the individual (10) in response to any or all of the OSA questions (40), and/or the individual's operating style aspects that have been revealed through administration of the OSA. The user profile may further include answers and/or results for any other assessment(s). A user profile may be stored in the storage device (70) or in any suitable location. In one embodiment, a user profile is accessible, at least in part, via the Internet (20).

In another embodiment, employers are provided with the ability to access at least a portion of an individual's user profile. Results of individuals' assessments may be stored in the storage device (70), such that the results are accessible by employers via the internet (20). In yet another embodiment, an employer receives individual (10) assessment results when the individual (10) electronically submits a resume to the employer, such as through the internet (20). In still another embodiment, the user interface (30) is provided on an employer's web site, such that one or more of the assessments are administered through the employer's web site. Accordingly, in this embodiment, the employer may obtain assessment results as soon as they are processed. Online assessments may thus be part of the employer's employee screening and/or intake process. Those of ordinary skill in the art will recognize other suitable uses for assessments and advantages provided by having access to assessment results.

In another embodiment, assessment results are operatively connected to an online job matching engine. In this embodiment, the individual (10) is a job candidate, and the job matching engine is configured to correlate the individual's assessment results with traits of jobs for which positions are open and available. The job matching engine may thus match an individual (10) with employment positions that are best suited for the individual (10) according to the individual's assessment results. Employers may provide a listing of traits that are desired in an ideal job candidate to facilitate this matching. These traits may be stored in the storage device (70). The job matching engine may include a processor comprising instructions to perform the matching. The processor may be in communication with the storage device (70). Other features and configurations of a job matching engine, and the manner in which such an engine uses assessment results to facilitate employment connections, will be apparent to those of ordinary skill in the art.

In yet another embodiment, a website is provided for administration of assessments and dissemination of results. In this embodiment, job seekers at any location with online access may log onto the website. An initial registration process is initiated in which the job seeker, or individual (10), completes a series of profile questions to result in the completion of an online resume. Based on the answers of the individual (10) to the profile questions, it is determined whether the individual (10) is eligible to take one or more assessments free of charge. The individual (10) then takes one or more of the assessments. The assessment results are immediately scored by an assessment engine (60). The individual's resume and assessment results are then stored in the storage device (70). The individual (10) then receives feedback on the assessment results via e-mail. Where a plurality of individuals have registered, and each has a respective user profile, the user profiles may be stored in a database in the storage device (70). Suitable variations and alternatives will be apparent to those of ordinary skill in the art.

In the present example, employers are permitted to post jobs on the website. Each time an individual (10) applies for a position, the employer is notified electronically. The employer may view the individual's application, resume, and/or assessment results, at least in part, simultaneously. These may be viewed through the website or in an e-mail sent to the employer. Employers may request that any potential hires register at the web site to take the assessment(s). Employers may also be provided the ability to request a search of the database of user profiles to find candidates that are best suited to fill their open positions based on the information contained in the user profiles. Suitable variations and alternatives will be apparent to those of ordinary skill in the art.

While embodiments have been discussed in the context of computer systems, it will be appreciated that the OSA and/or any other assessment may be administered, at least in part, outside of the computer context. By way of example only, the user interface (30) may be substituted by or be supplemented by one or more sheets of paper. Thus, the questions (40) may be asked, at least in part, in paper form. Similarly, answers (50) may be provided, at least in part, in paper form. In another embodiment, the user interface (30) comprises a person who asks the questions (40) orally and receives the answers (50) from the individual (10) orally. The assessment engine (60) may also comprise a human scoring the answers (50) “manually,” regardless of the form in which the questions (40) are asked and the form in which the answers (50) are received. Other suitable alternatives will be apparent to those of ordinary skill in the art.

Having shown and described various embodiments and concepts of the invention, further adaptations of the methods and systems described herein can be accomplished by appropriate modifications by one of ordinary skill in the art without departing from the scope of the invention. Several of such potential alternatives, modifications, and variations have been mentioned, and others will be apparent to those skilled in the art in light of the foregoing teachings. Accordingly, the invention is intended to embrace all such alternatives, modifications and variations as may fall within the spirit and scope of the appended claims and is understood not to be limited to the details of structure and operation shown and described in the specification and drawings.

1. A computer implemented method for assessing a person's operating style, the method comprising:
(a) administering an operating style assessment test to a person, the test comprising a plurality of test questions devised to determine aspects of the person's operating style, wherein each of the test questions corresponds to one of a plurality of question categories, wherein each question category corresponds to one of a plurality of operating style aspects, the plurality of operating style aspects comprising a plurality of drives and a plurality of thinking strategies;
(b) receiving answers from the person in response to the test questions;
(c) processing the answers to produce a plurality of operating style scores, each operating style score corresponding to one of the plurality of categories;
(d) determining which of the operating style aspects are present within the person's operating style based on the operating style scores; and
(e) producing one or more assessment results comprising reporting aspects determined to be present within the person's operating style.

2. The method of claim 1, wherein the plurality of question categories comprises four or more of the following: team player, charger, reserved, people driven, sustained focus, rapid paced, barrier breaker, fact finder, actual, and potential.

3. The method of claim 1, wherein the plurality of drives comprises charger, people driven, sustained focus, and fact finder.

4. The method of claim 1, wherein the plurality of thinking strategies comprises actual and potential.

5. The method of claim 1, wherein at least one of the operating style aspects is in conceptual opposition with another of the operating style aspects.

6. The method of claim 1, wherein each answer is represented by a number, wherein the step of determining which of the operating style aspects are present within the person's operating style comprises adding numbers representing answers to produce a plurality of answer sums.

7. The method of claim 6, wherein each answer sum corresponds to one of the question categories, wherein the step of determining which of the operating style aspects are present within the person's operating style further comprises determining a plurality of answer sum differences.

8. The method of claim 7, wherein there is an even number of operating style aspects exceeding two, wherein each answer sum difference corresponds to a pair of the operating style aspects.

9. The method of claim 8, wherein each of the pairs of operating style aspects is associated with at least one numerical threshold, wherein the step of determining which of the operating style aspects are present within the person's operating style further comprises comparing the answer sum differences to respective thresholds.

10. The method of claim 1, wherein each of the question categories further corresponds to one of a plurality of dimensions, each dimension having two or more of the question categories corresponding thereto.

11. The method of claim 10, wherein the plurality of dimensions comprises leadership, effects of others, work pace, knowledge handling, and thinking strategy.

12. The method of claim 10, wherein each dimension corresponds with two question categories, wherein one question category of the two corresponds to an operating style aspect that is in conceptual opposition with the operating style aspect corresponding to the other question category of the two.

13. A method of determining aspects of a person's operating style, the method comprising:
(a) asking the person a plurality of questions relating to the person's operating style, wherein each of the questions corresponds to one of a plurality of categories, wherein each of the categories corresponds to a potential aspect of the person's operating style, wherein each of the categories further corresponds to one of a plurality of dimensions, each dimension having more than one of the potential aspects corresponding thereto, each dimension further having more than one of the categories corresponding thereto;
(b) receiving answers to the plurality of questions, each answer being represented by a numerical value, wherein each answer corresponds to the same category as the corresponding question answered;
(c) adding the numerical values representing the answers corresponding to each category to determine an answer sum for each category;
(d) grouping the answer sums into answer sum groups, each answer sum group corresponding to one of the dimensions;
(e) determining the difference between the answer sums in each answer sum group to produce a plurality of group differences, each group difference having a numerical value;
(f) comparing the numerical value of each group difference to a threshold associated with the dimension to which the respective answer sum groups correspond; and
(g) determining aspects of the person's operating style based on the comparison of the numerical value of each group difference to each respective threshold.

14. The method of claim 13, wherein each dimension corresponds with two potential aspects in conceptual opposition with each other.

15. The method of claim 13, wherein each numerical value representing an answer is selected by the person from a group of at least three numbers.

16. A method for assessing a person's drive, the method comprising:
(a) asking an individual a plurality of questions relating to an operating style, wherein the operating style includes a first plurality of drives;
(b) receiving answers from the individual in response to the plurality of questions, the answers to the plurality of questions being indicative of the person's operating style;
(c) scoring the answers to the plurality of questions, wherein the scoring indicates that the person's operating style includes a second plurality of drives, the second plurality of drives being at least a portion of the first plurality of drives, wherein one of the drives of the second plurality of drives is a strongest drive;
(d) asking a plurality of follow-up questions to determine which of the second plurality of drives is the strongest drive;
(e) receiving answers to the plurality of follow-up questions;
(f) processing the answers to the plurality of follow-up questions to determine which of the second plurality of drives is the strongest drive; and
(g) reporting the strongest drive.

17. The method of claim 16, wherein at least a portion of the answers to the plurality of questions are provided in numerical form, wherein numbers representing answers provided in numerical form are added to produce a plurality of answer sum sets, wherein one answer sum from each set is subtracted from another answer sum in the same set to produce an answer sum difference corresponding to the respective set, wherein the step of scoring comprises comparing the each answer sum difference to a one or more threshold values associated with the corresponding set.

18. A method for assessing a person's thinking strategy, the method comprising:
(a) asking an individual a plurality of questions relating to operating style, wherein operating style includes thinking strategy;
(b) receiving answers from the individual in response to the plurality of questions, the answers being indicative of the person's operating style;
(c) scoring the answers to determine the individual's thinking strategy; and
(d) reporting the individual's thinking strategy.

19. The method of claim 18, wherein thinking strategy includes aspects comprising actual and potential.

20. The method of claim 19, wherein thinking strategy includes aspects further comprising actual/potential and potential/actual.
